(19) United States
(12) Patent Application Publication
(10) Pub. No.: US 2022/0206736 A1
(43) Pub. Date: Jun. 30, 2022

(54) INFORMATION PROCESSING APPARATUS, INFORMATION PROCESSING SYSTEM, AND NON-TRANSITORY COMPUTER READABLE MEDIUM

(71) Applicant: FUJIFILM Business Innovation Corp., Tokyo (JP)

(72) Inventor: Ryosuke SUZUKI, Kanagawa (JP)

(73) Assignee: FUJIFILM Business Innovation Corp., Tokyo (JP)

(21) Appl. No.: 17/314,063

(22) Filed: May 7, 2021

(30) Foreign Application Priority Data
Dec. 25, 2020 (JP) 2020-217914

(51) Int. Cl. G06F 3/14; G06T 3/40; G06T 7/13; G06F 3/147; G02B 27/01

(52) U.S. Cl. CPC G06F 3/1423; G06T 3/40; G06T 7/13; G02B 2027/014; G02B 27/0172; G02B 27/0179; G02B 2027/0185; G06F 3/147

(57) ABSTRACT

An information processing apparatus includes: a display that displays a virtual screen superimposed on real space; and a processor configured to, instead of causing a content of a screen to be displayed on a display screen of an external apparatus, cause the content to be displayed as the virtual screen superimposed on the display screen.

### CROSS-REFERENCE TO RELATED APPLICATIONS

This application is based on and claims priority under 35 USC 119 from Japanese Patent Application No. 2020-217914 filed Dec. 25, 2020.

### BACKGROUND

### (i) Technical Field

The present disclosure relates to an information processing apparatus, an information processing system, and a non-transitory computer readable medium.

### (ii) Related Art

The recent advancement of technology such as mobile computing and networking leads to occasions of work such as telework using an information terminal apparatus. In this case, a user works not only at home but also, for example, in a place they have gone, on occasions.

Japanese Unexamined Patent Application Publication No. 2014-174507 describes a multi display system including an information terminal that displays a real screen and an augmented reality (AR) glasses apparatus that displays a virtual screen as an AR display screen different from the real screen. The AR glasses apparatus detects the position range of the real screen displayed by the information terminal and controls the position of the displayed virtual screen to prevent the position range of the virtual screen from overlapping the detected position range of the real screen.

### SUMMARY

For example, when the user works in a place they have gone, a third party may look furtively at an image displayed on the display screen of an information terminal apparatus such as a notebook computer, a tablet terminal, or a smartphone.

Aspects of non-limiting embodiments of the present disclosure relate to an information processing apparatus, an information processing system, and a non-transitory computer readable medium that enable information used during working to be hidden from a furtive look at the display screen by a third party as compared to a case where the information is displayed on the furtively observable display screen of an information terminal apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including: a display that displays a virtual screen superimposed on real space; and a processor configured to, instead of causing a content of a screen to be displayed on a display screen of an external apparatus, cause the content to be displayed as the virtual screen superimposed on the display screen.

### BRIEF DESCRIPTION OF THE DRAWINGS

An exemplary embodiment of the present disclosure will be described in detail based on the following figures, wherein:

FIG. 1 is a view illustrating an outline of an information processing system of this exemplary embodiment;

FIG. 2 is a view illustrating the configuration of a terminal apparatus;

FIG. 3 is a view illustrating the configuration of an AR glasses apparatus;

FIG. 4 is a flowchart illustrating the operation of the information processing system;

FIG. 5 is a view illustrating an example of pointers displayed on the display in step 5105 in FIG. 4;

FIGS. 6A, 6B, 6C, and 6D are each a view illustrating a different screen displayed on the display in step 5109 in FIG. 4;

FIG. 7 illustrates a first example of an AR screen seen by a user when the AR glasses apparatus is used;

FIGS. 8A and 8B each illustrate a second example of the AR screen seen by the user when the AR glasses apparatus is used;

FIG. 9 illustrates a third example of the AR screen seen by the user when the AR glasses apparatus is used;

FIG. 10 illustrates a fourth example of the AR screen seen by the user when the AR glasses apparatus is used;

FIG. 11 illustrates a fifth example of the AR screen seen by the user when the AR glasses apparatus is used;

FIGS. 12A and 12B illustrate a sixth example of the AR screen seen by the user when the AR glasses apparatus is used; and

FIG. 13 illustrates a seventh example of the AR screen seen by the user when the AR glasses apparatus is used.

### DETAILED DESCRIPTION

### Overall Configuration Of Information Processing System 1

Hereinafter, an exemplary embodiment of the present disclosure will be described in detail with reference to the attached drawings.

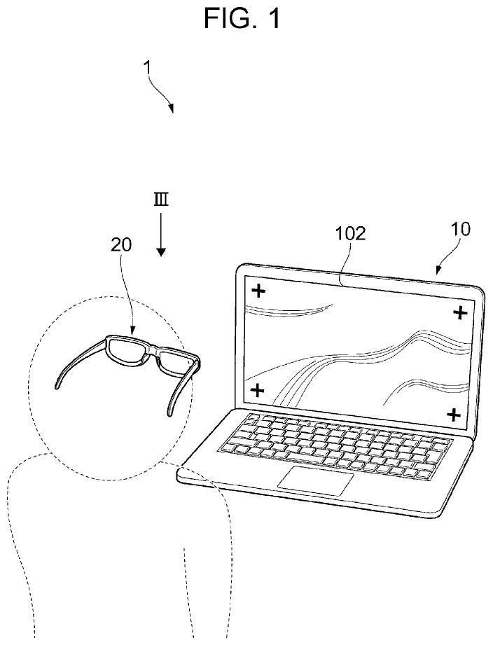

FIG. 1 is a view illustrating an outline of an information processing system 1 of this exemplary embodiment.

The information processing system 1 illustrated in FIG. 1 includes a terminal apparatus 10 and an AR glasses apparatus 20. In this case, the AR glasses apparatus 20 is worn on the head of a user who operates the terminal apparatus 10.

The terminal apparatus 10 is an example of an external apparatus including a display 102 present in reality. The terminal apparatus 10 is, for example, a general-purpose personal computer (PC). In the terminal apparatus 10, various pieces of application software are run under the control of the operating system (OS), and thereby information processing or the like of this exemplary embodiment is performed.

The AR glasses apparatus 20 is an example of an information processing apparatus and displays AR to the user. The term “AR” stands for augmented reality and is used in displaying a virtual screen to the user in such a manner as to superimpose the virtual screen on the real space. The term “virtual screen” is used in displaying an image generated by a computer and seeable with a device such as the AR glasses apparatus 20. The term “real space” denotes a space present in reality.

### Configuration of Terminal Apparatus 10

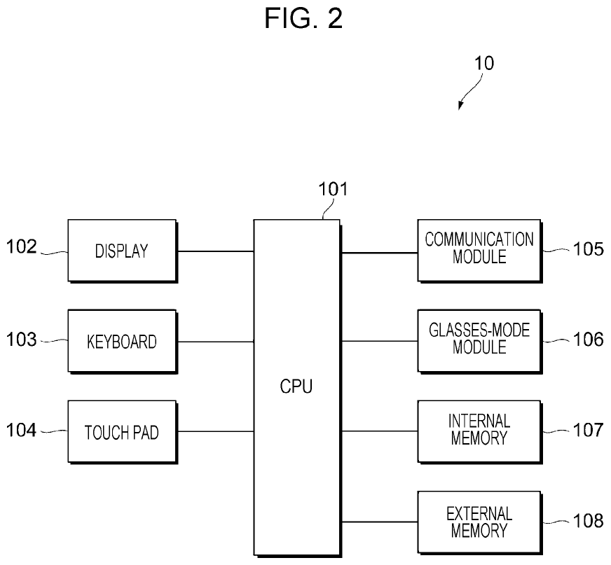

FIG. 2 is a view illustrating the hardware configuration of the terminal apparatus 10.

The terminal apparatus 10 illustrated in FIG. 2 includes a central processing unit (CPU) 101 that controls the components of the terminal apparatus 10 by running programs, the display 102 that displays information such as an image, a keyboard 103 used to input characters and the like, a touch pad 104 that serves as a pointing device, a communication module 105 used to communicate with the AR glasses apparatus 20, a glasses-mode module 106 that serves as a module for operations in a glasses mode, an internal memory 107 that stores system data and internal data, an external memory 108 that serves as an auxiliary memory device, and other components.

The CPU 101 is an example of a processor and runs programs such as the OS (basic software) and application software.

In this exemplary embodiment, the internal memory 107 and the external memory 108 are semiconductor memories. The internal memory 107 has a read only memory (ROM) storing a basic input output system (BIOS) and the like and a random access memory (RAM) used as a main memory. The CPU 101 and the internal memory 107 are included in the computer. The CPU 101 uses the RAM as a work space for programs. The external memory 108 is a storage such as a hard disk drive (HDD) or a solid state drive (SSD) and stores firmware, application software, and the like.

The display 102 is an example of a display screen and is composed of, for example, a liquid crystal display or an organic electro luminescent (EL) display. In this exemplary embodiment, information such as an image is displayed on the surface (that is, a display surface) of the display 102.

The keyboard 103 is also an input device used when the user inputs characters and the like.

The touch pad 104 is also an input device and is used for moving the cursor displayed on the display 102, scrolling the screen, and other operations. Instead of the touch pad 104, a mouse, a trackball, or other devices may be used.

The communication module 105 is a communication interface for communicating with an external apparatus.

The glasses-mode module 106 controls the content of a screen to be displayed in the glasses mode. The glasses-mode module 106 does not necessarily have to be provided and may be implemented by running application software by using the CPU 101, the internal memory 107, and the external memory 108.

### Configuration of AR Glasses Apparatus 20

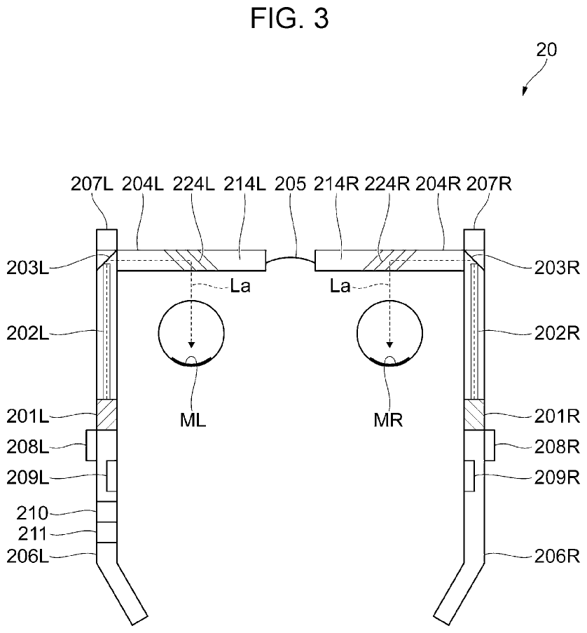

FIG. 3 is a view illustrating the configuration of the AR glasses apparatus 20.

FIG. 3 illustrates the AR glasses apparatus 20 viewed in the direction III in FIG. 1. Reference L is suffixed to the reference numeral of each member located on the left side of the AR glasses apparatus 20 worn by the user, and reference R is suffixed to the reference numeral of each member located on the right side.

Various systems such as a virtual image projection system and a retinal projection system are provided for the AR glasses apparatus 20 for the AR displaying, and any system is usable. The AR glasses apparatus 20 has, for example, the following configuration. This AR glasses apparatus 20 uses the retinal projection system. The AR glasses apparatus 20 shaped like glasses is herein illustrated; however, the shape and the form thereof are not particularly limited as long as the AR glasses apparatus 20 is an apparatus that is worn on the head of the user and that displays AR to the user.

The AR glasses apparatus 20 includes laser light sources 201L and 201R, optical fibers 202L and 202R, mirrors 203L and 203R, lens parts 204L and 204R, a bridge 205, temples 206L and 206R, cameras 207L and 207R, microphones 208L and 208R, speakers 209L and 209R, a communication module 210, and a glasses-mode module 211.

The laser light sources 201L and 201R are light sources for generating a virtual screen. A full color virtual screen may be generated by using laser beams in three colors of red, green, and blue from the laser light sources 201L and 201R through high-speed change-over.

The optical fibers 202L and 202R are respectively provided inside the temples 206L and 206R and guide laser light beams La emitted from the laser light sources 201L and 201R to the mirrors 203L and 203R, respectively. The optical fibers 202L and 202R may be formed from glass or plastics.

The mirrors 203L and 203R reflect the travelling laser light beams La to turn at almost a right angle and guide the laser light beams La to the lens parts 204L and 204R, respectively. The mirrors 203L and 203R are swingable vertically and horizontally, and each incident angle with a corresponding one of the lens parts 204L and 204R thereby varies. This also causes each position at which the corresponding laser light beam La reaches a corresponding one of retinas ML and MR of the user to vary vertically and horizontally. As the result, the user may see a two-dimensional image as a virtual screen.

The lens parts 204L and 204R each internally have a corresponding one of light guide parts 214L and 214R and a corresponding one of reflection parts 224L and 224R. The light guide parts 214L and 214R respectively guide, toward the bridge 205, the laser light beams La totally reflected by the mirrors 203L and 203R to change the traveling directions at the respective angles. The reflection parts 224L and 224R respectively reflect, almost at right angles, the laser light beams La respectively guided by the light guide parts 214L and 214R and change the travelling directions of the laser light beams La toward the retinas ML and MR of the user, respectively.

The lens parts 204L and 204R are translucent members that transmit visible light, and the user may see the real space through the lens parts 204L and 204R. This enables the user to see the virtual screen superimposed on the real space.

Note that the term “lens parts” is herein conveniently used due to the glasses shape of the AR glasses apparatus 20; however, the lens parts 204L and 204R do not actually have to have a lens function. That is, the lens parts 204L and 204R do not have to have an optical function of refracting light.

The bridge 205 supports the AR glasses apparatus 20 on the nose of the user and is a member for the user to wear the AR glasses apparatus 20 on their head.

The temples 206L and 206R support the AR glasses apparatus 20 on the ears of the user and are members for the user to wear the AR glasses apparatus 20 on their head.

The cameras 207L and 207R capture an image in front of the user. In this exemplary embodiment, an image of the terminal apparatus 10 is mainly captured.

The microphones 208L and 208R acquire sound such as voice around the AR glasses apparatus 20, while the speakers 209L and 209R output sound such as voice. The use of the microphones 208L and 208R and the speakers 209L and 209R enables the information processing system 1 to be utilized for, for example, a remote meeting. The speakers 209L and 209R may be, for example, a bone conduction speaker from a viewpoint of prevention of sound leakage to the outside.

The communication module 210 is a communication interface for communicating with an external apparatus.

The glasses-mode module 211 controls the operations of the laser light sources 201L and 201R and the mirrors 203L and 203R in the glasses mode. The glasses-mode module 211 may be implemented by running control software for controlling the laser light sources 201L and 201R and the mirrors 203L and 203R by using a CPU, an internal memory, and an external memory. The CPU is an example of the processor.

In this exemplary embodiment, the laser light sources 201L and 201R, the optical fibers 202L and 202R, the mirrors 203L and 203R, and the lens parts 204L and 204R function as a display that displays a virtual screen superimposed on the real space to the user.

### Operation of Information Processing System 1

In the information processing system 1 of this exemplary embodiment, the terminal apparatus 10 and the AR glasses apparatus 20 are paired by using the communication module 105 and the communication module 210. The pairing is performed through wireless connection such as Bluetooth (registered trademark) but is not limited thereto. The terminal apparatus 10 and the AR glasses apparatus 20 may be connected through a wireless local area network (LAN), the Internet, or the like. Further, the connection is not limited to the wireless connection and may be wired connection through a digital visual interface (DVI), a high-definition multimedia interface (HDMI) (registered trademark), DisplayPort, a universal serial bus (USB), IEEE1394, RS-232C, or the like.

The information processing system 1 displays and presents a screen to the user, by using the display 102 of the terminal apparatus 10 or the AR glasses apparatus 20.

In the information processing system 1, a virtual screen is displayed with the AR glasses apparatus 20 when the content of a screen to be displayed (display content) is required to be hidden from a third party. At this time, a different screen is displayed on the display 102. This will be described in detail later. In contrast, when the display content is not required to be hidden from the third party, the screen is displayed on the display 102 of the terminal apparatus 10. At this time, the AR glasses apparatus 20 does not display the virtual screen. Hereinafter, in some cases in this exemplary embodiment, a mode in which the information processing system 1 operates in the former case is referred to as a glasses mode as an example of a first mode, and a mode in which the information processing system 1 operates in the latter case is referred to as a normal mode as an example of a second mode.

The configuration will be described below.

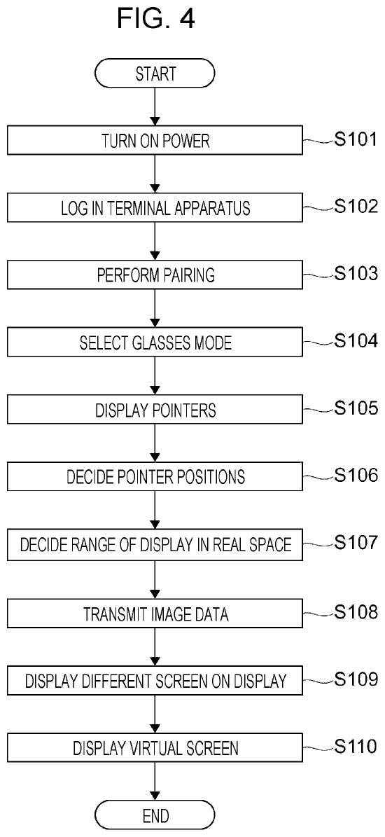

FIG. 4 is a flowchart of the operation of the information processing system 1.

First, the user turns on the terminal apparatus 10 and the AR glasses apparatus 20 (step S101). This activates the mechanism components including the glasses-mode module 106 of the terminal apparatus 10 and the mechanism components including the glasses-mode module 211 of the AR glasses apparatus 20.

The user then logs in the terminal apparatus 10 (step S102).

Pairing is performed between the terminal apparatus 10 and the AR glasses apparatus 20 (step S103). The paring may be performed by the user through setting operations or may be performed automatically.

After the completion of the paring, the user selects the glasses mode from the setting screen of the terminal apparatus 10 (step S104). Pointers pointing at the position of the display 102 of the terminal apparatus 10 are displayed (step S105).

The cameras 207L and 207R of the AR glasses apparatus 20 capture an image of the display 102 of the terminal apparatus 10. The glasses-mode module 211 decides the positions of the pointers on the basis of the captured image of the display 102 (step S106).

Further, the glasses-mode module 211 decides the range of the display 102 in the real space on the basis of the positions of the pointers (step S107).

The terminal apparatus 10 transmits, to the AR glasses apparatus 20, image data regarding a screen to be displayed originally on the display 102 (step S108). Note that a different screen, not the screen to be originally displayed, is displayed on the display 102 of the terminal apparatus 10 (step S109). The pointers are still displayed.

A screen to be displayed originally on the display 102 is displayed as a virtual screen on the AR glasses apparatus 20 (step S110). At this time, the virtual screen is displayed in such a manner as to fit to the display 102. That is, it looks to the user as if the virtual screen were attached to the display 102.

In the AR glasses apparatus 20 as described above, the content of the screen to be displayed on the actually present display 102 of the terminal apparatus 10 is displayed in such a manner as to be superimposed as the virtual screen on the display 102, instead of being displayed on the display 102.

At this time, the AR glasses apparatus 20 recognizes the range of the display 102 and displays the virtual screen in accordance with the recognized range. The range of the display 102 is recognized on the basis of the pointers displayed on the display 102 in the example described above.

### SCREEN EXAMPLES

Hereinafter, screen examples in this exemplary embodiment will be described.

### Screen Example 1

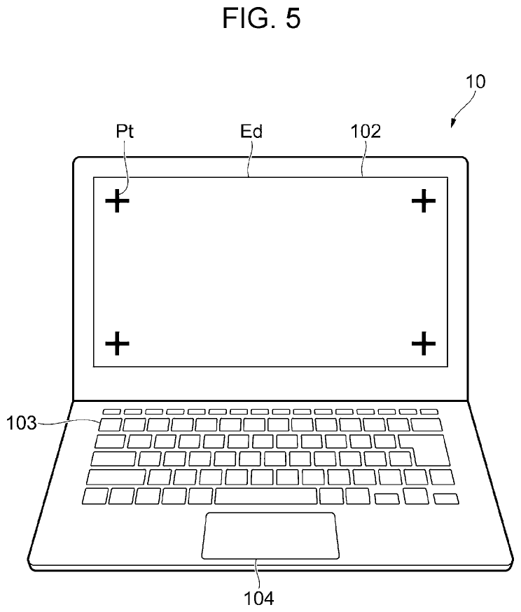

FIG. 5 is a view illustrating an example of pointers Pt displayed on the display 102 in step 5105 in FIG. 4.

The pointers Pt illustrated in FIG. 5 have a +shape and are displayed in the four corners of the display 102. In step 5107 in FIG. 4, the glasses-mode module 211 decides the range of the display 102 on the basis of the positions of the pointers Pt in the captured image. The shape and the size of each pointer Pt are not particularly limited. Any object displayed on the display 102 suffices to serve as the pointer Pt. The term “object” denotes an object displayed on the display 102. The glasses-mode module 211 recognizes the shape of an object such as the pointer Pt in the captured image and obtains the position of the object in the captured image.

The pointer Pt does not have to be necessarily displayed, and the range of the display 102 may be decided by a different method. For example, the range of the display 102 may be recognized by detecting edges Ed of the display 102. In this case, the glasses-mode module 211 decides the range of the display 102 on the basis of the positions of the edges Ed of the display 102 by using image recognition or the like.

### Screen Example 2

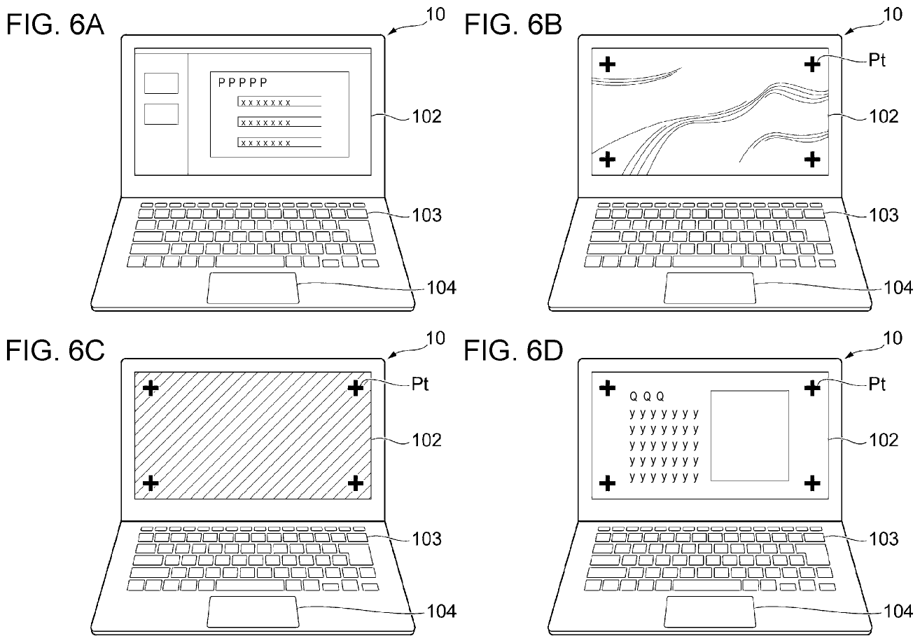

FIGS. 6A to 6D are each a view illustrating a different screen displayed on the display 102 in step 5109 in FIG. 4.

FIG. 6A among these illustrates the screen to be displayed originally on the display 102. FIGS. 6B to 6D each illustrate a screen displayed actually on the display 102.

FIG. 6B illustrates a case where a screen saver is displayed as the different screen. FIG. 6C illustrates a case where a black screen is displayed as the different screen. Further, FIG. 6D illustrates a case where a screen having no relation to FIG. 6A is displayed as the different screen. The screen in FIG. 6D is, for example, a dummy screen.

As described above, when the AR glasses apparatus 20 displays a virtual screen Gk, the terminal apparatus 10 displays a screen different from the virtual screen Gk on the display 102. Screen Example 3

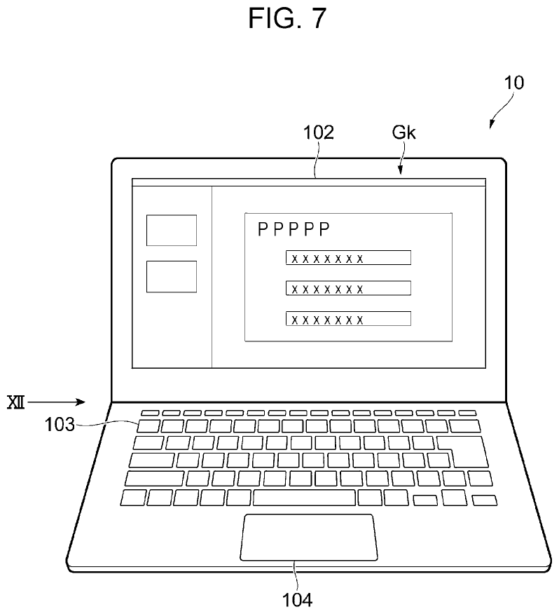

FIG. 7 illustrates a first example of the AR screen seen by the user when the AR glasses apparatus 20 is used.

At this time, the user sees the terminal apparatus 10 present in the real space through the lens parts 204L and 204R. The screen to be displayed originally on the display 102 is displayed as the virtual screen Gk. The content of the displayed virtual screen Gk is identical to the screen in FIG. 6A.

The virtual screen Gk is displayed in such a manner as to fit to the display 102. It thus looks to the user as if the virtual screen Gk were attached to the display 102. That is, the AR screen in this case includes the terminal apparatus 10 present in the real space and the virtual screen Gk displayed as if the virtual screen Gk were attached to the display 102 of the terminal apparatus 10. Actually, the same state as where the screen is displayed on the display 102 may be reproduced. The user may also see the keyboard 103 and the touch pad 104 in the real space. In response to the user operation of the keyboard 103 and the touch pad 104, the terminal apparatus 10 generates a screen based on the operation and transmits screen image data to the AR glasses apparatus 20. The virtual screen Gk based on the operation is thereby displayed.

Movement of the head of the user causes a change in distance between the display 102 and the AR glasses apparatus 20 on occasions. In this case, the positions of the pointers Pt or the edges Ed of the display 102 are changed. In this case, the glasses-mode module 211 thus sets the range of the display 102 again in response to the change and displays the virtual screen Gk in accordance with the range.

### Screen Example 4

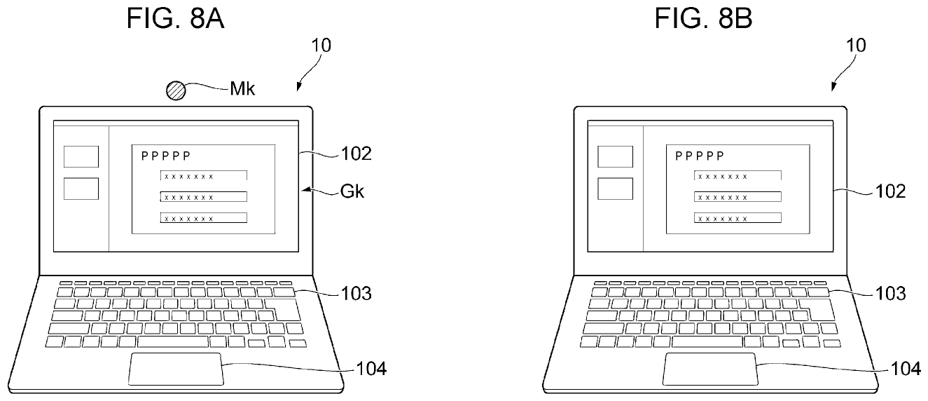

FIGS. 8A and 8B each illustrate a second example of the AR screen seen by the user when the AR glasses apparatus 20 is used.

In this example, switching is performed between the glasses mode and the normal mode on the basis of the display content. In the glasses mode, the content of a screen to be displayed on the display 102 is displayed in such a manner as to be superimposed as the virtual screen Gk on the display 102, instead of being displayed on the display 102. In the normal mode, the content of the screen to be displayed on the display 102 is displayed on the display 102, and the virtual screen Gk is not displayed. In this example, the glasses mode is set when the display content has secret information, and the normal mode is set when the display content does not have the secret information. The term “secret information” denotes information not allowed to be known to a third party.

FIG. 8A illustrates a screen displayed in the glasses mode, and FIG. 8B illustrates a screen displayed in the normal mode.

Since the display content has secret information in the glasses mode, the screen to be originally displayed on the display 102 of the terminal apparatus 10 is not displayed on the display 102 and is displayed as the virtual screen Gk in the AR glasses apparatus 20. In contrast, since the display content does not have secret information in the normal mode, the screen to be displayed originally on the display 102 of the terminal apparatus 10 is displayed as it is and is not displayed as the virtual screen Gk on the AR glasses apparatus 20.

The switching between the glasses mode and the normal mode may be performed manually by the user. Alternatively, the terminal apparatus 10 may perform the switching after determining whether the display content has secret information. Specifically, when an electronic document includes a keyword such as Confidential, or when a screen for logging in a server system or a screen subsequent thereto is displayed, the terminal apparatus 10 determines that secret information is included. In addition, when an electronic document designated in advance by the user is displayed, or when an electronic document included in the folder designated in advance by the user is displayed, the terminal apparatus 10 determines that secret information is included.

In the glasses mode, an indicator for the glasses mode may be displayed in the virtual screen on the AR glasses apparatus 20. In FIG. 8A, a marker Mk indicating the glasses mode is displayed adjacent to the virtual screen, and thereby the glasses mode is notified to the user. In the example in FIG. 8A, the marker Mk represents the character string “glasses mode”. However, the marker Mk is not limited thereto and may be an icon or the like. When determining that the secret information is included, the terminal apparatus 10 transmits, to the AR glasses apparatus 20, image data regarding the marker Mk together with image data regarding the screen to be displayed on the display 102. The marker Mk may thereby be displayed.

### Screen Example 5

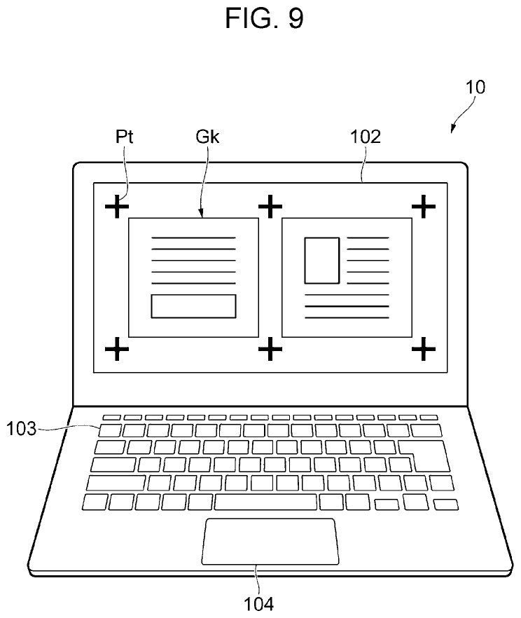

FIG. 9 illustrates a third example of the AR screen seen by the user when the AR glasses apparatus 20 is used.

In this example, the area of the display 102 of the terminal apparatus 10 is separated into two, one of the separated screens is displayed as the virtual screen Gk, and the other is displayed as the real space.

The left screen of the separated screens is herein displayed as the virtual screen Gk on the display 102 of the terminal apparatus 10, and the right screen is displayed as the real space. Note that in the terminal apparatus 10, a screen saver is displayed on the virtual screen Gk. In this example, the area of each separated screen is represented by using the pointers Pt. On the basis of the pointers Pt, the display range of the virtual screen Gk is decided in the AR glasses apparatus 20.

It may also be said that the virtual screen is displayed in a partial area of the display 102, and the content of the screen to be displayed on the display 102 is displayed in the other area of the display 102. In other words, the virtual screen Gk is displayed in such a manner as to be reduced with respect to the size of the display 102.

In this case, one of the separated screens includes secret information, and the other does not. Such a displaying form is used, for example, when explanation is made with the other one of the separated screens presented to a person different from the user. Note that the number of separated screens is not limited to two and may be three or more.

### Screen Example 6

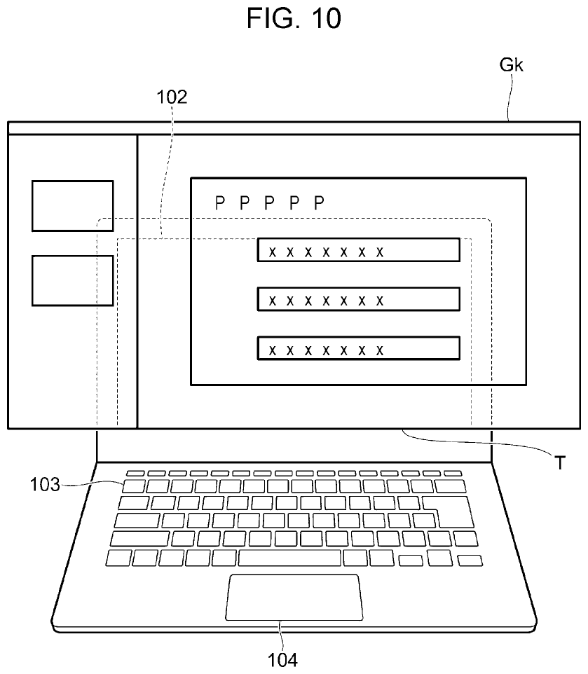

FIG. 10 illustrates a fourth example of the AR screen seen by the user when the AR glasses apparatus 20 is used.

In this example, the virtual screen Gk is displayed in such a manner as to be enlarged with respect to the size of the display 102 represented using the dotted lines.

At this time, the virtual screen Gk may be enlarged such that a base of the virtual screen Gk is not displaced from the position of a base T of the display 102. This prevents the keyboard 103 and the touch pad 104 below the display 102 from being hidden and thus contributes to the convenience for the user.

Screen Examples 5 and 6 may be regarded as examples of a case where the size of the virtual screen Gk is made different from the size of the display 102.

### Screen Example 7

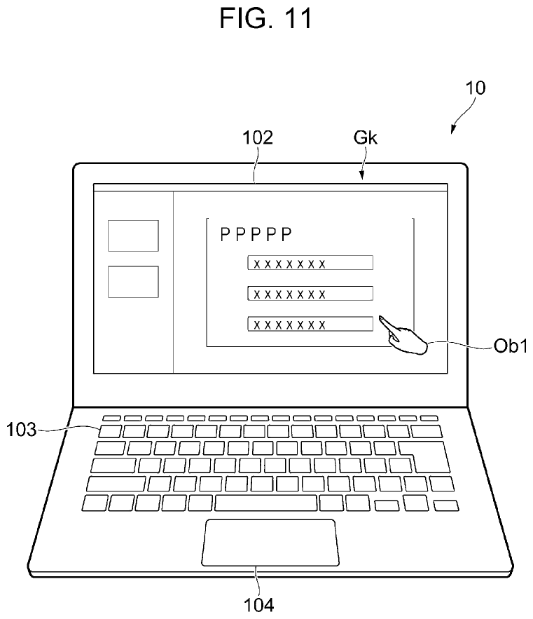

FIG. 11 illustrates a fifth example of the AR screen seen by the user when the AR glasses apparatus 20 is used.

In this example, an object Ob1 representing a hand of the user is displayed in the virtual screen Gk. For example, in a case where the display 102 is a touch panel, the user needs to touch the display 102 for user operation. In this case, the hand of the user is present in front of the display 102 before the user touches the display 102. Nevertheless, the presence of the virtual screen Gk displayed in the range of the display 102 prevents the user from recognizing their own hand. To address this, the object Ob1 representing the hand of the user is displayed in the virtual screen Gk to thereby enable the user to make sure of the position of the hand.

In this case, the glasses-mode module 211 detects the hand of the user located in front of the display 102 on the basis of the image captured with the cameras 207L and 207R. Whether the hand of the user is located in front of the display 102 may be determined on the basis of the range of the display 102. If the hand of the user is present in front of the display 102, the glasses-mode module 211 generates image data for displaying the object Ob1 representing the hand of the user in the virtual screen Gk. Note that the glasses-mode module 211 herein detects whether the hand of the user is present and displays the object Ob1 representing the hand of the user; however, the glasses-mode module 211 may transmit an image captured with the cameras 207L and 207R to the terminal apparatus 10, and the terminal apparatus 10 may perform the same processing. In addition, in response to the detection of the presence of the hand of the user in front of the display 102, control may be performed to display the actual hand of the user in front of the virtual screen Gk. Alternatively, an object such as a stylus for operating the touch panel may be detected to perform display control in the same manner. Through the operations as described above, the input instrument such as the hand of the user or the stylus for operating the display 102 is represented by the AR glasses apparatus 20, and the user is thereby enabled to see the input instrument. When the input instrument comes in contact with the display 102, a touch panel operation is thereby achieved.

### Screen Example 8

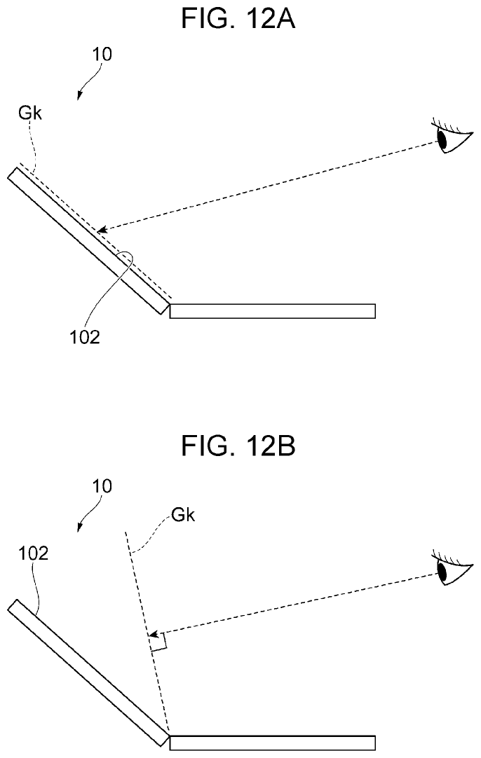

FIGS. 12A and 12B illustrate a sixth example of the AR screen seen by the user when the AR glasses apparatus 20 is used.

In this example, the angle of the virtual screen Gk is corrected. FIG. 12A illustrates the virtual screen Gk before the correction, and FIG. 12B illustrates the virtual screen Gk after the correction. FIGS. 12A and 12B are viewed in the XII direction in FIG. 7. Specifically, in FIG. 12A, the virtual screen Gk is displayed along the surface of the display 102 and does not face the user straight. At this time, the user looks at the virtual screen Gk at an angle. In contrast, in FIG. 12B, the angle is corrected to cause the virtual screen Gk to face the user straight. In this case, the line of sight of the user is almost orthogonal to the virtual screen Gk. At this time, the user may look at the virtual screen Gk from the front. Note that in this case, to cause the virtual screen Gk to face the user straight on, the angle made with the virtual screen Gk on the vertical plane is corrected; however, an angle made on the horizontal plane may be corrected.

### Screen Example 9

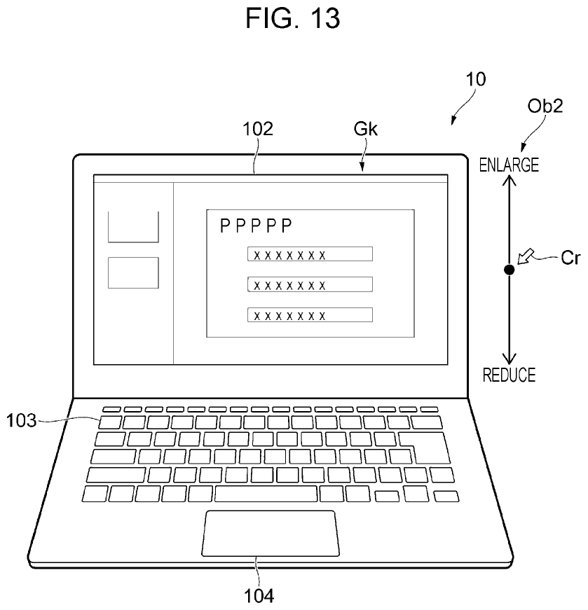

FIG. 13 illustrates a seventh example of the AR screen seen by the user when the AR glasses apparatus 20 is used.

In this example, a cursor Cr displayed as a part of the virtual screen Gk may be moved in a range larger than the range of the display 102. The cursor Cr is displayed as a part of the virtual screen Gk. In addition, an object Ob2 provided adjacent to the display 102 may be operated as the virtual screen Gk.

In this case, the object Ob2 is, for example, a slider for enlarging and reducing the display 102 as described in Screen Examples 5 and 6. Instead of the slider, buttons for enlarging and reducing the display 102 may be displayed. The object Ob2 may also be a toggle button or the like for toggling between the glasses mode and the normal mode. In this case, the object Ob2 and the cursor Cr may be regarded not only as the content of a screen to be displayed as the virtual screen Gk originally on the display 102 but also as an example of an object for operating the virtual screen Gk.

With the information processing system 1 described above, information used during working is hidden from a furtive look at the display 102 by a third party.

The recent advancement of technology such as mobile computing and networking has led to an increase in work or the like, for example, in telework with the information terminal apparatus 10. In this case, the user works not only at home but also at a café or a fast-food restaurant near the place they have gone, a shared office, and the like, on occasions. In this exemplary embodiment, even in such an environment, information used during working is hidden from a furtive look at the display 102 by the third party.

### Program

The process by the AR glasses apparatus 20 in this exemplary embodiment described above is executed by running a program such as control software.

The process executed by the AR glasses apparatus 20 in this exemplary embodiment may be regarded as a program to cause a computer to execute a process including: acquiring the content of a screen to be displayed on the display 102 from the terminal apparatus 10 including the display; and, instead of displaying the acquired content on the display 102, displaying the acquired content as the virtual screen Gk superimposed on the display 102 with a display that displays the virtual screen Gk superimposed on real space.

Note that the program implementing this exemplary embodiment may be provided not only through a communication medium but also in such a manner as to be stored in a recording medium such as a compact disc (CD)-ROM.

The exemplary embodiment has heretofore been described. The technical scope of the disclosure is not limited to the scope of the exemplary embodiment. From the description of the scope of claims, it is apparent that the technical scope of the disclosure includes various modifications and improvements made to the exemplary embodiment.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a display that displays a virtual screen superimposed on real space; and
a processor configured to:
instead of causing a content of a screen to be displayed on a display screen of an external apparatus, cause the content to be displayed as the virtual screen superimposed on the display screen.

2. The information processing apparatus according to claim 1,
wherein the processor is configured to recognize a range of the display screen and display the virtual screen in accordance with the recognized range.

3. The information processing apparatus according to claim 2,
wherein the range of the display screen is recognized by using an object displayed on the display screen.

4. The information processing apparatus according to claim 2,
wherein the range of the display screen is recognized by detecting an edge of the display screen.

5. The information processing apparatus according to claim 2,
wherein the processor is configured to further detect an input instrument located in front of the display screen on a basis of the range of the display screen and display the input instrument or an object representing the input instrument in the virtual screen.

6. The information processing apparatus according to claim 1,
wherein the processor is configured to perform switching between a first mode and a second mode on a basis of the content, the first mode causing the content to be displayed as the virtual screen superimposed on the display screen, instead of causing the content to be displayed on the display screen, the second mode causing the content to be displayed on the display screen without displaying the virtual screen.

7. The information processing apparatus according to claim 6,
wherein the processor is configured to set the first mode when the content has secret information and set the second mode when the content does not have the secret information.

8. The information processing apparatus according to claim 6,
wherein the processor is configured to cause an indicator indicating the first mode to be displayed in the virtual screen in the first mode.

9. The information processing apparatus according to claim 1,
wherein the processor is configured to make a size of the virtual screen different from a size of the display screen.

10. The information processing apparatus according to claim 9,
wherein the processor is configured to cause the virtual screen to be displayed in an area of the display screen and cause the content to be displayed in a remaining area other than the area of the display screen.

11. The information processing apparatus according to claim 9,
wherein the processor is configured to cause the virtual screen enlarged with respect to the size of the display screen to be displayed without displacing a position of a base of the virtual screen from the display screen.

12. The information processing apparatus according to claim 1,
wherein the processor is configured to cause the virtual screen to face a user straight.

13. The information processing apparatus according to claim 1,
wherein the processor is configured to cause the content to be displayed as the virtual screen and further cause an object for operating the virtual screen to be displayed.

14. An information processing system comprising:
an information processing apparatus including a display that displays a virtual screen superimposed on real space and a processor configured to perform control to display the virtual screen; and
an external apparatus that includes a display screen and that performs pairing with the information processing apparatus,
wherein the processor is configured to:
instead of causing a content of a screen to be displayed on the display screen, cause the content to be displayed as the virtual screen superimposed on the display screen.

15. The information processing system according to claim 14,
wherein when the information processing apparatus displays the virtual screen, a screen different from the virtual screen is displayed on the display screen of the external apparatus.

16. A non-transitory computer readable medium storing a program causing a computer to execute a process comprising:
acquiring a content of a screen to be displayed on a display screen from an external apparatus including the display screen; and,
instead of displaying the acquired content on the display screen, displaying the acquired content as a virtual screen superimposed on the display screen with a display that displays the virtual screen superimposed on real space.
